(19) United States
(12) Patent Application Publication
(10) Pub. No.: US 2014/0214751 A1
(43) Pub. Date: Jul. 31, 2014

(54) Mixed collaborative filtering-content analysis model

(71) Applicant: Hewlett-Packard Development Company, L.P., Houston, TX (US)

(72) Inventor: Niranjan Damera-Venkata, Chennai (IN)

(21) Appl. No.: 13/754,558

(22) Filed: Jan. 30, 2013

(51) Int. Cl. G06N 5/02

(52) U.S. Cl. CPC G06N 5/02
USPC 706/52

(57) ABSTRACT

Identification of a content item and identification of a user are received. A mixed collaborative filtering-content analysis model is used to determine a predicted probability of interest of the user in the content item. The predicted probability of interest of the user in the content item is output.

### BACKGROUND

The abundance of information that users encounter online can be breathtaking. When shopping for a book, for example, whereas before a user was limited to the books available at a bookstore, now the user can choose from nearly any book that is in print. As another example, when looking for information, whereas before a user may have been limited to an encyclopedia or the relevant books in a library, now the user can browse among what can seem to be an almost infinite number of web pages regarding the information.

### BRIEF DESCRIPTION OF THE DRAWINGS

FIG. 1 is a diagram of an example system in relation to which a mixed collaborative filtering-content analysis model can be employed.

FIG. 2 is a flowchart of an example method for recommending content items to a user based on a mixed collaborative filtering-content analysis model.

FIG. 3 is a diagram of an example server system that can implement a mixed collaborative filtering-content analysis model.

### DETAILED DESCRIPTION

As noted in the background section, the amount of information that users encounter online, such as on the Internet, is nearly limitless. Such information can be considered as content items, where a content item may be an item like a book, movie, or physical object that a user can purchase, a web page, a social network status update, and so on. To assist users in selecting content items for consumption, such as for viewing, purchase, and so on, recommendation systems have been developed.

One type of recommendation system uses a collaborative filtering model to recommend content items of interest to a user based on data regarding the user and other users in relation to other content items. Collaborative filtering models are essentially black box models, in which the data is input into the model, and the model teases from this data predicted probabilities of interest of a user for content items, regardless of what the content items actually are, and without analyzing the content items themselves. However, collaborative filtering models can need inordinate amounts of data regarding a user in order to provide accurate and relevant predictions. For a user who has not purchased many content items, has not ranked many content items, and/or who has not viewed many content items, such models are of limited predictive use.

Disclosed herein are techniques in which a collaborative filtering model is augmented with content analysis in the form of a mixed collaborative filtering-content analysis model that overcomes these shortcomings of existing collaborative filtering models. Unlike a collaborative filtering model, content analysis is not a black box model, and further analyzes content items to learn what each content item is. Based upon a user's implicitly or explicitly stated preferences, content analysis can then recommend relevant content items. Also unlike a collaborative filtering model, content analysis does not typically use data of other users regarding the content items when making predictions for a given user. Further unlike a collaborative filtering model, content analysis requires just a small amount of data regarding a user to provide accurate and relevant predictions.

In the techniques disclosed herein, the collaborative filtering part of a mixed collaborative filtering-content analysis model assesses a predicted probability of interest of a user in a content item from collaborative filtering of user interest data of a number of users regarding a number of content items. The content analysis part assesses the predicted probability of interest of the user in the content item from topic analysis of the content item in relation to topics as to just the user him or herself. The mixed collaborative filtering-content analysis model is initially biased towards content analysis in determining the predictive probability of interest of the user in a content item, and becomes more biased towards collaborative filtering as more data regarding the user and other content items becomes available.

One type of collaborative filtering model that can be augmented with content analysis using techniques disclosed herein is a latent factor model. A latent factor model determines unobserved aspects, or factors, of content items, as well as unobserved factors of a user, to predict for a given content item whether the user will likely have interest. The factors are unobserved, or latent, in that they are not explicitly specified for any content item or user, and indeed ultimately do not matter, so long as they are predictive. In fact, in a latent factor model, the labels or names of the factors that the model ultimately determines can be and remain unknown.

A latent factor model can express a predicted probability of interest of a user u, which can also be referred to as a score, and which may have a value between zero and one, in a content item v as

\hat{p}ᵤᵥ∝sᵥ^{T}sᵤ. (1)

In this equation, \hat{p}ᵤᵥ is the predicted probability of interest of the user u in the content item v, sᵥ is the vector of latent factors for the content item v that the model has determined, and sᵤ is the vector of latent factors for the user u that the model has determined. Each vector includes for each latent factor an associated value. For the user u, sᵤ includes a value for each latent factor indicating the user's determined interest in that factor, whereas for the content item v, sᵥ includes a value for each latent factor indicating the extent to which the content item v is demonstrative of that factor. The transpose of the vector sᵥ is multiplied by the vector sᵤ to yield the predicted probability of interest \hat{p}ᵤᵥ. Additional terms for user bias and/or product popularity bias can also be added.

In a latent factor model, the vectors sᵤ and sᵥ become more accurate with more data. That is, as the user u rates, views, or purchases, and so on, more content items, the vector sᵤ becomes more accurate in its predictive ability. Similarly, as users rate, view, or purchase, and so on, the content item v, the vector sᵥ becomes more accurate in its predictive ability. Therefore, \hat{p}ᵤᵥ is most accurate for a user u that has generated a large amount of data and for a content item v for which other users have generated a large amount of data.

The latent factor model is augmented with content analysis to yield a mixed latent factor-content analysis model, which is more generally a mixed collaborative filtering-content analysis model. The mixed model can express a predicted probability of interest of a user u in a content item v as

$${\hat{p}}_{uv} ∝ {( {s}_{v} + {\sum }_{k} {α}_{v} ( k ) {T}^{V} ( k ) )}^{T} ( {s}_{u} + {\sum }_{k} {α}_{u} ( k ) {T}^{U} ( k ) ) . \qquad ( 2 )$$

In this equation, \hat{p}ᵤᵥ is the product of the transpose of a vector for the content item v and a vector for the user u. The vector for the content item v includes the latent profile for the content item v (i.e., the vector sᵥ) from the latent factor model augmented by a content analysis summation for this content item. The vector for the user u includes the latent profile for the user u (i.e., the vector sᵤ) from the latent factor model augmented by a content analysis summation for this user. Additional terms for user bias and/or product popularity bias can also be added, as before.

In the content analysis summations, αᵥ(k) is the (scalar) k-th topic coefficient within the vector αᵥ for the content item v, and αᵤ(k) is the k-th topic coefficient for the user u within the vector αᵤ for the user u, where k={1, . . . , K}, such that there are K total topics. Furthermore, T^{V}(k) is the k-th vector within a topic matrix T^{V} for all content items V, where the content item v ∈ V. Similarly, T^{U}(k) is the k-th vector within a topic matrix T^{U} for all users U, where the user u ∈ U.

For the content item v, the topic coefficient αᵥ(k) indicates the extent to which the content item v is demonstrative of the topic k. That is, the topic coefficient αᵥ(k) is a weighting for the topic k as to the content item v. The vector αᵥ for the content item v can be generated by analyzing the content thereof for each topic k. The vector αᵥ is generated just once for a content item v, and does not change so long as the content thereof does not change.

For the user u, the topic coefficient αᵤ(k) indicates the user's interest in the topic k. That is, the topic coefficient αᵤ(k) is a weighting of the topic k as to the user u. For instance, the topic coefficient αᵤ(k) can be an aggregate, or average, of the topic coefficient αᵥ(k) of each content item v that the user has purchased, visited, viewed, etc., for the topic k. In such an implementation, a user u just has to have purchased, visited, viewed, etc., one content item v in order for the vector αᵤ to be generated. The vector αᵤ can be updated each time the user has purchased, visited, viewed, etc., another content item k.

The k-th vector T^{V}(k) within the topic matrix T^{V} for all content items V is the latent factor profile for the content analysis part of the mixed model, akin to the vector sᵥ for the content item v. As such, the topic matrix T^{V} can be considered as the matrix formed by the collections of the vectors T^{V}(k) for all topics K. Likewise, the k-th vector T^{U}(k) within the matrix T^{U} for all users U is the latent factor profile for the content analysis part of the mixed model, akin to the vector sᵤ for the user u. As such, the topic matrix T^{U} can be considered as the matrix formed by the collections of the vectors T^{U}(k) for all topics K. The vectors T^{V}(k) and T^{U}(k) thus permit the content analysis afforded by the topic coefficients αᵥ(k) and αᵤ (k) to augment the vectors sᵥ and sᵤ within the latent factor model to achieve the mixed model.

The topics in relation to which content analysis provides predictive capability differ from the latent factors in relation to which the latent factor model provides predictive capability. The topics are known, whereas the latent factors are not. The topics are preselected, such as by the designer of the model or a system administrator, whereas the latent factors are not. The topic coefficients for a content item are determined by analyzing the content item irrespective of other content items and irrespective of user data regarding the content item, and the topic coefficients for a user are determined by analyzing the user's history of other content items—including just one content item. By comparison, the latent factor profile for a content item (i.e., the vector sᵥ) is determined by analyzing other content items and/or by analyzing user data in relation to the content item and/or other content items, in a collaborative filtering manner. The latent factor profile for a user (i.e., the vector sᵤ) is likewise determined by analyzing other users and/or by analyzing data of the user and/or other users in relation to content items, in a collaborative filtering manner.

For a user u and a content item v, the predicted probability of interest \hat{p}ᵤᵥ of the user in the item is dependent primarily upon the content analysis summations where the user has generated little data in relation to other content items and where other users have generated little data in relation to the content item. That is, where there is little data, \hat{p}ᵤᵥ is dependent primarily upon the content analysis part of the mixed model. As the user generates more data in relation to other content items and/or as other users generate more data in relation to the content item, \hat{p}ᵤᵥ becomes dependent on both the latent factor part and the content analysis part of the mixed model. When the user generates a large amount of data in relation to other content items and other users generate a large amount of data in relation to the content item, \hat{p}ᵤᵥ becomes dependent primarily upon the latent factor part of the mixed model.

The shift in dependence from the content analysis part of the model towards the latent factor part of the model is a result of the regularization that occurs within model fitting. If there is not much data, then the vectors sᵥ and sᵤ are driven towards zero in this process. As the amount of data increases, then the vectors sᵥ and sᵤ become larger in this process.

For the latent factor part of a mixed latent factor-content analysis model, and for the collaborative filtering part of a mixed collaborative filtering-content analysis model, the predictive probabilities of interest can be generated based on user data regarding content items of one of two types: ranking data or event data. Ranking data inherently includes both positive and negative interest data regarding content items. For example, a user may indicate that he or she likes certain content items, and dislikes other content items. The content items that the user has liked constitute positive interest data, and the content items that the user has disliked constitute negative interest data. Content items that the user has not yet rated in this way constitute neither positive nor negative interest data.

By comparison, event data inherently includes just positive data regarding content items. For example, a user may have purchased certain content items, from which it can be presumed that the user likes these items, and thus which constitute positive interest data regarding the purchased items. However, it cannot be inferred that just because a user has not purchased a certain content item that the user does not like this item. Therefore, event data does not inherently include negative data regarding content items.

This can be problematic, because latent factor and other types of collaborative filtering models can require negative interest data in order to provide accurate predictive probabilities of interest. A Jaccard similarity coefficient technique, or another predetermined technique, can be used to extend event data to provide negative interest data as well as positive of interest data by using similarity coefficients. For two content items A and B, the Jaccard similarity coefficient is

$$\frac{⋂ ( u ( A ) , u ( B ) )}{⋃ ( u ( A ) , u ( B ) )} ,$$

where u(A) are the users that correspond to the content item A and u(B) are the users that correspond to the content item B. For instance, the former users may be those who have purchased the content item A and the latter users may be those who have purchased the content item B.

The Jaccard similarity coefficient measures the similarity between two content items. Therefore, if a given user has purchased and thus likes the content item A but has not purchased the content item B, and the Jaccard similarity coefficient for the content items A and B is below a predetermined threshold, then the content item B can be concluded as being disliked by the user, since most users who purchased the content item A did not also purchase the content item B. Likewise, if the user has purchased and thus likes the content item B but has not purchased the content item A, and the Jaccard similarity coefficient for the content items A and B is below the threshold, then the content item A can be concluded as being disliked by the user. In this way, even though event data inherently provides just positive interest data, negative interest data can be generated so that the collaborative filtering part of a mixed collaborative filtering-content analysis model can operate properly.

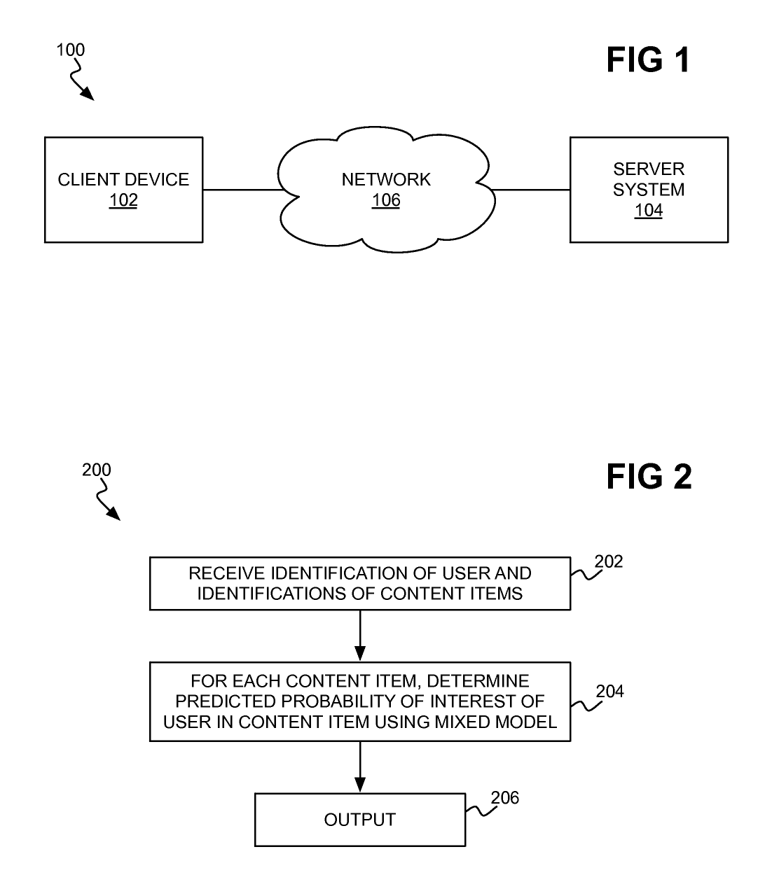

FIG. 1 shows an example system 100 in relation to which the mixed collaborative filtering-content analysis model that has been described can be employed. The system 100 includes a client device 102 and a server system 104 interconnected by a network 106. The client device 102 can be the computing or other device of an end user, such as a laptop or desktop computer, a tablet device, a mobile device like a smartphone, and so on. The network 106 may be or include the Internet, an intranet, an extranet, a mobile network, a telephony network, and so on.

The server system 104 includes one or more computing devices, such as server computers. The server system 104 interacts with the client device 102 to provide one or more recommended content items. The content items are recommended by using the mixed collaborative filtering-content analysis model that has been described in relation to the user operating the client device 102. For example, the server system 104 can be or include a web server, which serves suggested web pages to the user as recommended in accordance with the mixed model. The server system 104 can be or include a social networking server, which shows social network status updates to the user as identified in accordance with the mixed model. The server system 104 can be or include an electronic commerce server, which shows suggested products for purchase to the user in accordance with the mixed model.

FIG. 2 shows an example method 200 for recommending content items to a user. The method 200 can be implemented as computer-readable code executable by a processor of a computing device. The code may be stored on a non-transitory computer-readable data storage medium. For example, the method 200 may be executed by the server system 104 that has been described.

The identification of a user and identifications of content items are received (202). For each content item, a predicted probability of interest of the user in the content item is determined using the mixed collaborative filtering-content analysis model that has been described (204). The method 200 finally performs output (206). Such output can include outputting the predicted probabilities of interest of the user in the content items that have been generated, for instance.

Such output can further include displaying to the user an ordered list of the content items having the highest predicted probabilities of interest of the user. For example, a user may request that web pages that the user is likely to be interested in viewing be displayed, responsive to which such web pages are identified and displayed as those content items having the highest predicted probabilities of interest. The user may access a social network, responsive to which status updates are identified and displayed as those content items having the highest predicted probabilities of interest. The user may access an electronic commerce provider, responsive to which products are identified and displayed as those content items having the highest predicted probabilities of interest.

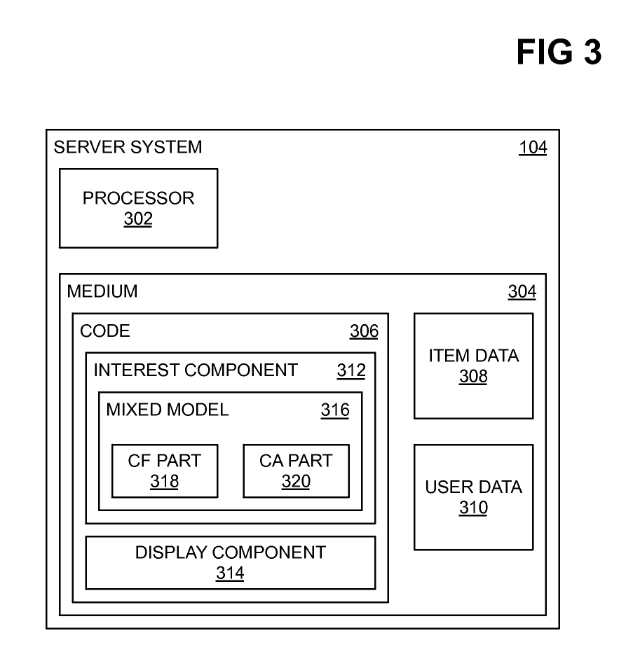

FIG. 3 shows an example server system 104 that be used in conjunction with the system 100 to perform the method 200. The server system 104 includes at least a processor 302 and a non-transitory computer-readable data storage medium 304 storing computer-readable code 306 executable by the processor 302. The server system 104 may include other hardware as well, in addition to the processor 302 and the medium 304.

The computer-readable data storage medium 304 stores content item data 308 and user data 310 in addition to the computer-readable code 306.

The content item data 308 concerns a number of content items, whereas the user data 310 concerns a number of users. The data 308 and 310 may be related. For instance, the data 308 and 310 as a whole can include ranking data, event data, or other data regarding rankings or events of the users in relation to the content items. The content item data 308 may further include topic-related information regarding the content items, and similarly the user data 310 may further include topic-related information regarding the users.

The computer-readable code 306 implements at least an interest-determining component 312 and an item-displaying component 314. In general, the interest-determining component 312 performs parts 202 and/or 204 of the method 200, whereas the item-displaying component 314 performs part 206 of the method 200. The interest-determining component 302 includes a mixed collaborative filtering-content analysis model 316, such as a latent factor model. The mixed model 316 includes a collaborative filtering part 318 as has been described, such as a latent factor part, as well as a content analysis part 320.

The mixed collaborative filtering-content analysis model 316 is used by the interest-determining component 312 to determine a predicted probability of interest of each user in each content item based on the item data 308 and the user data 310. The collaborative filtering part 318 performs the collaborative filtering aspects of this analysis, whereas the content analysis part 320 performs the content analysis aspects of this analysis. As such, the mixed model 316 is more biased towards the content analysis part 320 when the item data 308 and/or the user data 310 is limited in amount for a given user as to a given content item, and becomes more biased towards the collaborative filtering part 318 as such data 308 and/or data 310 increases, as has been described.

I claim:

1. A method comprising:
receiving, by a computing device, identification of a content item and identification of a user;
determining, by the computing device, a predicted probability of interest of the user in the content item using a mixed collaborative filtering-content analysis model; and
outputting, by the computing device, the predicted probability of interest of the user in the content item.

2. The method of claim 1, wherein the mixed collaborative filtering-content analysis model comprises:
a collaborative filtering part that assesses the predicted probability of interest of the user in the content item from collaborative filtering of user interest data of a plurality of users regarding a plurality of content items; and
a content analysis part that assesses the predicted probability of interest of the user in the content item from topic analysis of the content item in relation to a plurality of topics as to just the user him or herself.

3. The method of claim 1, wherein the mixed collaborative filtering-content analysis model is initially biased towards content analysis in determining the predicted probability of interest of the user in the content item and becomes more biased towards collaborative filtering in determining the predicted probability of interest of the user in the content item as more data regarding the user and other content items becomes available.

4. The method of claim 1, wherein the mixed collaborative filtering-content analysis model augments a collaborative filtering model with content analysis.

5. The method of claim 4, wherein the collaborative filtering model is a latent factor model.

6. The method of claim 5, wherein the latent factor model expresses the predicted probability of interest of the user in the content item as being based on multiplication of a vector corresponding to the user multiplied by a transposition of a vector corresponding to the content item,
and wherein the vector corresponding to the user comprises data for the user regarding a plurality of latent factors, and the vector corresponding to the content item comprises data for the content item regarding the latent factors.

7. The method of claim 6, wherein the mixed collaborative filtering-content analysis model augments the latent filtering model with the content analysis by:
adding to the vector corresponding to the user a summation of a plurality of vectors of a user topic matrix multiplied by a plurality of corresponding topic coefficients for the user; and
adding to the vector corresponding to the content item a summation of a plurality of vectors of a content item topic matrix multiplied by a plurality of corresponding topic coefficients for the content item,
wherein the corresponding topic coefficients for the user comprise data for the user regarding a plurality of topics, and the corresponding topic coefficients for the content item comprise data for the content item regarding the topics.

8. The method of claim 4, wherein the collaborative filtering model is based on ranking data regarding the user, the ranking data providing both positive and negative interest data regarding other content items.

9. The method of claim 4, wherein the collaborative filtering model is based on event data regarding the user, the event data inherently providing just positive and not negative interest data regarding other content items,
wherein the event data is extended based on a predetermined technique to also provide the negative interest data regarding the other content items.

10. The method of claim 9, wherein the predetermined technique is a Jaccard similarity coefficient technique that extends the positive interest data regarding the other content items to generate the negative interest data regarding the other content items based on a plurality of similarity coefficients.

11. A non-transitory computer-readable data storage medium storing computer-readable code executable by a computing system to perform a method comprising:
for each content item of a plurality of content items, as a given content item, determining a predicted probability of interest of a user in the given content item from a mixed collaborative filtering-content analysis model; and
displaying to the user a sub-plurality of the content items for which the user has the predicted probabilities of interest that are highest.

12. The non-transitory computer-readable data storage medium of claim 11, wherein the mixed collaborative filtering-content analysis model comprises:
a collaborative filtering part that assesses the predicted probability of interest of the user in the given content item from collaborative filtering of user interest data of a plurality of users regarding the content items; and
a content analysis part that assesses the predicted probability of interest of the user in the given content item from topic analysis of the given content item in relation to a plurality of topics as to just the user him or herself,
and wherein the mixed collaborative filtering-content analysis model is initially biased towards the content analysis part in determining the predicted probability of interest of the user in the given content item and becomes more biased towards the collaborative filtering part in determining the predicted probability of interest of the user in the given content item as more data regarding the user and the content items becomes available.

13. The non-transitory computer-readable data storage medium of claim 11, wherein the mixed collaborative filtering-content analysis model augments a latent factor model with content analysis.

14. A system comprising:
a processor;
a non-transitory computer-readable data storage medium storing computer-readable code executable by the processor;
an interest-determining component implemented by the computer-readable code to, for each user of a plurality of users, as a given user, determine a predicted probability of interest of the given user in each content item of a plurality of content items based on a mixed collaborative filtering-content analysis model; and
an item-displaying component implemented by the computer-readable code to provide to each user, as the given user, a sub-plurality of the content items for which the given user has the predicted probabilities of interest that are the highest.

15. The system of claim 14, wherein the mixed collaborative filtering-content analysis model augments a collaborative filtering model with content analysis,
wherein the collaborative filtering model assesses the predicted probability of interest of the given user in each content item from collaborative filtering of user interest data of the users regarding the content items,
wherein the content analysis assesses the predicted probability of interest of the given user in each content item, as a given content item, from topic analysis of the given content item in relation to a plurality of topics as to just the given user him or herself,
and wherein the mixed collaborative filtering-content analysis model is initially biased towards the content analysis in determining the predicted probability of interest of the given user in each content item and becomes more biased towards the collaborative filtering model in determining the predicted probability of interest of the given user in each content item as more data regarding the given user and the content items becomes available.
